(19) United States
(12) Patent Application Publication
(10) Pub. No.: US 2013/0019424 A1
(43) Pub. Date: Jan. 24, 2013

(54) Decorating Tool

(71) Applicant: Matthew Page, Newthorpe (GB)

(72) Inventor: Matthew Page, Newthorpe (GB)

(21) Appl. No.: 13/295,323

(22) Filed: Nov. 14, 2011

(30) Foreign Application Priority Data
Jul. 18, 2011 (GB) 1112315.5

(51) Int. Cl. A46B 3/08; B25G 3/24

(52) U.S. Cl. 15/145; 15/104.001

(57) ABSTRACT

A decorating tool for applying and removing material from a surface comprises a handle assembly that includes selectively separable clamping members that are defined at least in part by first and second handle portions of a handle body. The decorating tool also includes a tool head which includes a retention portion that lies towards a first end thereof and an operative portion which lies towards a second end of the tool head opposite the first end. The operative portion of the tool head is to apply or remove material from a surface. The clamping members cooperate with one another to selectively clamp the retention portion of the tool head therebetween and thereby retain the tool head relative to the handle assembly. The clamping members also cooperate with the retention portion to position the operative portion of the tool head beyond the handle assembly.

### FIELD OF THE INVENTION

The present invention relates generally to a decorating tool, and more particularly, relating to a handle assembly and a tool head which form part of such a decorating tool.

### BACKGROUND OF THE INVENTION

Decorating tools include paint brushes, wallpaper smoothers, flexible filling knives, rigid stripping knives, chisel knives, trowels, paint and grout removers, grout finishers, and surface formers such as rasps and sanders.

A conventional decorating tool includes a handle to which is immovably secured a tool head. The tool head has an operative portion which is configured to provide the desired decorative functionality, e.g., painting, filling, scraping, and the like.

One drawback of such conventional decorating tools is that when the operative portion of the tool head becomes worn out or damaged, it is necessary for a user to purchase a completely new decorating tool.

Moreover, decorating tool suppliers are required to stock complete decorating tools including the handle and tool head. Typically, such decorating tools are manufactured in China,. and so, in most cases, the stocking of decorating tool suppliers requires the transportation of relatively bulky decorating tools over very large distances. This has an impact on the environment in terms of the CO₂ emissions generated by such transportation.

Furthermore, conventional decorating tools are discarded once they are no longer required, and typically end up in landfill sites because the constituent elements are difficult to recycle in their assembled state. Each conventional decorating tool is also relatively bulky,. and so the pressure on limited landfill resources is further increased.

Accordingly, there is a need for an improved decorating tool which provides the same degree of functionality expected by users of conventional decorating tools while having a reduced impact on the environment.

### SUMMARY OF THE INVENTION

The preferred embodiments of the present invention address this need by providing a decorating tool, for applying and removing material from a surface, comprising:
a handle assembly including selectively separable clamping members, the clamping members being defined at least in part by first and second handle portions of a handle body; and
a tool head including a retention portion lying towards a first end thereof and an operative portion lying towards a second end of the tool head opposite the first end, the operative portion being to apply or remove material from a surface;
the clamping members cooperating with one another to selectively clamp the retention portion of the tool head therebetween and thereby retain the tool head relative to the handle assembly; and
the clamping members cooperating with the retention portion to position the operative portion of the tool head beyond the handle assembly.

To achieve these and other advantages, in general, in one aspect, a decorating tool for applying and removing material from a surface is provided. The decorating tool includes the provision of clamping members that cooperate with one another to selectively clamp the retention portion of a tool head therebetween allows a user to separate the tool head from the handle assembly as desired, while having the clamping members cooperate with the retention portion to position the operative portion of the tool head beyond the handle assembly ensures that the operative portion of the tool head is always available for use by a user.

The ability to selectively separate the tool head and the handle assembly from one another allows a user to retain only one handle assembly for use with any number of tool heads, each of which may provide a different decorating functionality.

A user need only, therefore, swap or replace the tool head should the operative portion thereof become worn or damaged, or if different decorating functionality is required.

As a result, decorative tool suppliers need only stock a reduced number of handle assemblies together with a range of tool heads, thereby reducing the bulk and mass of decorating tool components that must be transported from a manufacturer and providing a commensurate reduction in the CO₂ footprint of each decorating tool.

Furthermore, the ability to readily separate the tool head and the handle assembly from one another greatly assists in the subsequent recycling of the separated components. In addition, in the unlikely event that, say, the tool head must be disposed of, the bulk of such a separate component is less than a conventional decorating tool (since the user retains the handle assembly of the invention), and so less material is consigned to landfill.

In general, in another aspect, a decorating tool for applying and removing material from a surface is provided, wherein the handle assembly preferably includes first and second mutually opposed clamping members.

The inclusion of first and second mutually opposed clamping members provides uniform loading on the tool head which helps to eliminate relative movement between the tool head and the handle assembly, allowing a user to exercise a desired degree of control over the operative portion of the tool head.

In general, in another aspect, a decorating tool for applying and removing material from a surface is provided, wherein each of the first and second clamping members includes respective first and second clamping member portions, the first clamping member portions selectively cooperating with one another to clamp the retention portion of a first tool head therebetween, and the second clamping member portions selectively cooperating with one another to clamp the retention portion of a second tool head therebetween, the retention portion of the first tool head having a greater thickness than the retention portion of the second tool head.

Such first and second clamping member portions allows the handle assembly to accommodate tool heads of different thicknesses, allowing a user to configure the decorating tool as required for a given task, e.g., painting with a thicker tool head that defines a paint brush or filling with a thinner tool head that defines a flexible blade.

In general, in another aspect, a decorating tool for applying and removing material from a surface is provided, wherein at least one first clamping member portion includes a first retention formation which is cooperable with a mutually engageable first retention formation in the retention portion of the first tool head to inhibit removal of the first tool head from between the first clamping member portions.

Such first retention formations assist the first clamping member portions in retaining a first, i.e. thicker, tool head relative to the handle assembly, and help to prevent inadvertent separation of the first tool head from the handle assembly.

In general, in another aspect, a decorating tool for applying and removing material from a surface is provided, wherein at least one first clamping member portion may include a first support formation which is cooperable with a mutually engageable first support formation in the retention portion of the first tool head to further reduce relative movement between the first tool head and the handle assembly.

The inclusion of such first support formations contributes to a user being able to exert an even greater degree of control over the operative portion of the first tool head.

In general, in another aspect, a decorating tool for applying and removing material from a surface is provided, wherein at least one second clamping member portion includes a primary retention formation which is cooperable with a mutually engageable primary retention formation in the retention portion of the second tool head to inhibit removal of the second tool head from between the second clamping member portions.

Such primary retention formations assist the second clamping member portions in retaining a second, i.e. thinner, tool head relative to the handle assembly, and help to prevent inadvertent separation of the second tool head from the handle assembly.

In general, in another aspect, a decorating tool for applying and removing material from a surface is provided, wherein at least one second clamping member portion may include a secondary retention formation which is cooperable with a mutually engageable secondary retention formation in the retention portion of the second tool head to further inhibit removal of the second tool head from between the second clamping member portions.

The inclusion of such a feature further helps to prevent inadvertent separation of the second tool head from the handle assembly.

In general, in another aspect, a decorating tool for applying and removing material from a surface is provided, wherein each second clamping member portion includes a primary retention formation which mutually engages with the primary retention formation of the other second clamping member portion and a secondary retention formation that mutually engages with the secondary retention formation of the other clamping member portion.

Such mutually engaging retention formations provide desired retention of the second tool head relative to the handle assembly while improving the structural integrity of the handle assembly.

In general, in another aspect, a decorating tool for applying and removing material from a surface is provided, wherein at least one second clamping member portion includes a second support formation which is abuttable against the retention portion of the second tool head. As a result, a user is able to exert an even greater degree of control over the operative portion of the second tool head.

In general, in another aspect, a decorating tool for applying and removing material from a surface is provided, wherein each of the first and second handle portions defines at least a second clamping member portion.

Such handle portions provide a desired degree of clamping of the tool head while presenting a user with the familiar appearance of a conventional decorating tool.

In general, in another aspect, a decorating tool for applying and removing material from a surface is provided, wherein each handle portion includes a corresponding first or second ferrule member, each of the first and second ferrule members defining at least a first clamping member portion.

The inclusion of first and second ferrule members provides a desired degree of clamping of the tool head while being readily manufacturable.

In general, in another aspect, a decorating tool for applying and removing material from a surface is provided, wherein the handle assembly includes a fastener to selectively secure the first and second handle portions to one another. The inclusion of such a fastener helps to ensure that the handle portions remain in clamping engagement with the tool head when desired while allowing ready separation of the handle portions when replacement of the tool head is required.

In general, in another aspect, a decorating tool for applying and removing material from a surface is provided, wherein the fastener may be defined by first and second mutually engageable fastener formations, each of which is integrally formed with a respective handle portion. Such an arrangement reduces the likelihood of the fastener becoming lost while providing the desired selective securing of one handle portion with the other.

In general, in another aspect, a decorating tool for applying and removing material from a surface is provided, wherein the handle assembly includes a biasing member to urge at least the first and second clamping member portions of one clamping member away from the first and second clamping member portions of the other clamping member.

The inclusion of a biasing member helps to increase the speed with which a user is able to replace one tool head with another.

In general, in another aspect, a decorating tool for applying and removing material from a surface is provided, wherein the first and second handle portions are movably coupled with one another to allow selective separation of the first and second clamping member portions from one another without completely separating one handle portion from the other.

Movably coupling the handle portions with one another in the foregoing manner allows the swapping of one tool head with another, as desired, while helping to ensure the handle portions remain correctly aligned with one another and that one handle portion does not become misplaced.

In general, in another aspect of the invention there is provided a handle assembly, for a decorating tool configured to apply or remove material from a surface, the handle assembly comprising selectively separable clamping members, the clamping members being defined at least in part by first and second handle portions of a handle body and being cooperable with one another to selectively clamp a retention portion of a tool head therebetween to retain the tool head relative to the handle assembly, the clamping members further being cooperable with the retention portion to position an operative portion of the tool head configured to apply or remove material from a surface beyond the handle assembly.

In general, in another aspect of the invention there is provided a tool head, for a decorating tool configured to apply or remove material from a surface, the tool head comprising a retention portion lying towards a first end thereof and an operative portion lying towards a second end of the tool head opposite the first end, the operative portion being to apply or remove material from a surface, the retention portion being clampable between clamping members defined at least in part by first and second handle portions of a handle body forming part of a handle assembly to retain the tool head relative to the handle assembly, and the retention portion being cooperable with the clamping members to position the operative portion of the tool head beyond the handle assembly.

The other aspects of the invention share the benefits associated with the corresponding features of the first aspect of the invention.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is an exploded side elevational view of the decorating tool, according to a first embodiment in a first configuration, constructed in accordance with the principles of the present invention;

FIG. 2(a) is a side elevational view of the decorating tool shown in FIG. 1;

FIG. 2(b) is a front elevational view of the decorating tool shown in FIG. 1;

FIG. 3 is a front elevational view of the first tool head forming part of the decorating tool shown in FIG. 1;

FIG. 4 is an exploded view of the decorating tool according to the first embodiment of the invention in a second configuration, constructed in accordance with the principles of the present invention;

FIG. 5(a) is a side elevational view of the decorating tool shown in FIG. 4;

FIG. 5(b) is a front elevational view of the decorating tool shown in FIG. 4;

FIG. 6 is a front elevational view of a second tool head forming part of the decorating tool shown in FIG. 4; and

FIG. 7 is a side elevational view from a first side of a decorating tool according to another embodiment of the invention.

### DETAILED DESCRIPTION OF THE INVENTION

A decorating tool according to a first embodiment of the invention is designated generally by the reference numeral 10.

The decorating tool 10 has a handle assembly 12 which includes selectively separable clamping members, and in the particular decorating tool shown, first and second mutually opposed clamping members 14, 16.

The decorating tool also includes a tool head 18 which has a retention portion 20 that lies towards a first end 22 of the tool head 18 and an operative portion 24 which lies towards a second end 26 of the tool head 18 that is opposite the first end 22.

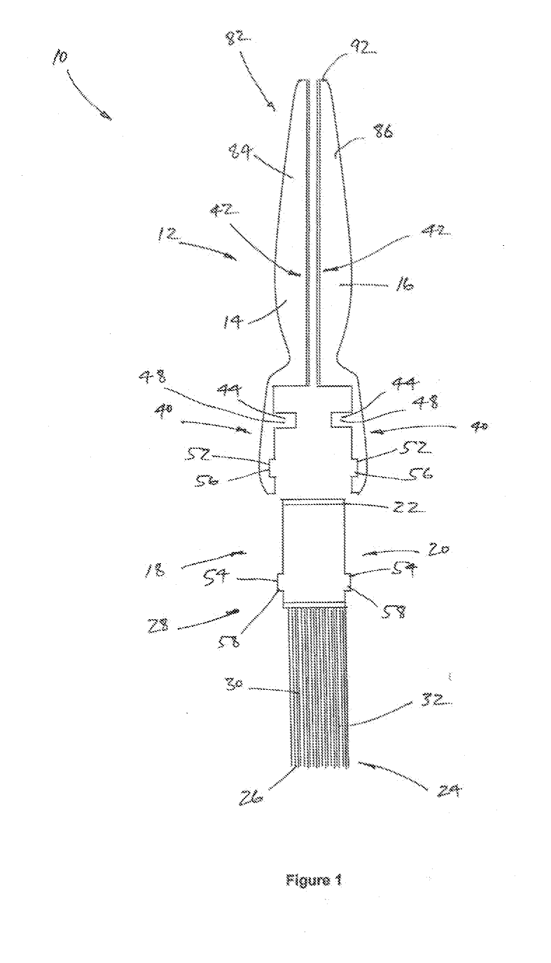

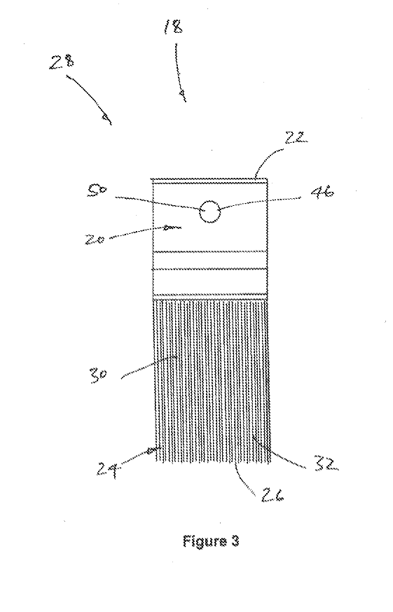

In a first configuration, as shown in FIGS. 1 to 3, the tool head 18 is a first tool head 28 and the operative portion 24 thereof is defined by the bristles 30 of a paint brush 32.

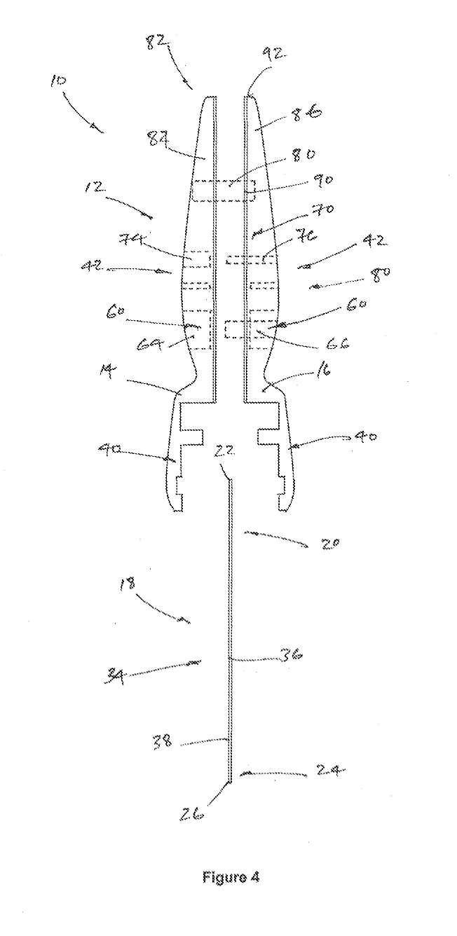

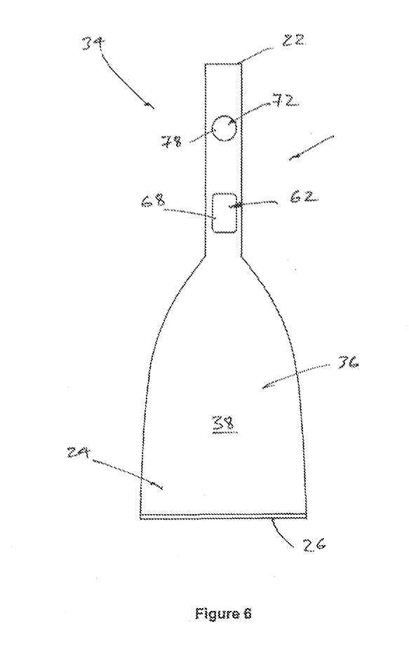

In other configurations, such as a second configuration shown in FIGS. 4 to 6 and described in more detail below, the tool head 18 is a second tool head 34 and the operative portion 24 thereof is defined by the rigid blade 36 of a stripping knife 38.

In still further configurations (not shown), the operative portion 24 of the tool head 18 may be defined by a portion of another tool, such as a wallpaper smoother, a flexible filling knife, a rigid scraper, a chisel knife, a trowel, a paint or grout remover, a grout finisher, or a surface former such as a rasp or sander.

In the foregoing manner the operative portion 24 of the tool head 18 is the distal region of the tool head 18 at or adjacent to the second end 26 thereof that is used to either apply or remove material from a surface.

The first and second clamping members 14, 16 cooperate with one another to selectively clamp the retention portion 20 of the tool head 18 therebetween so as to retain the tool head 18 relative to the handle assembly 12.

The first and second clamping members 14, 16 also cooperate with the retention portion 20 to position the operative portion 24 of the tool head 18 beyond the handle assembly 12, i.e., the operative portion 24 is exposed relative to the handle assembly 12 so as to be available to a user to apply or remove material from a surface, as required.

In the embodiment shown, each of the first and second clamping members 14, 16 includes respective first and second clamping member portions 40, 42.

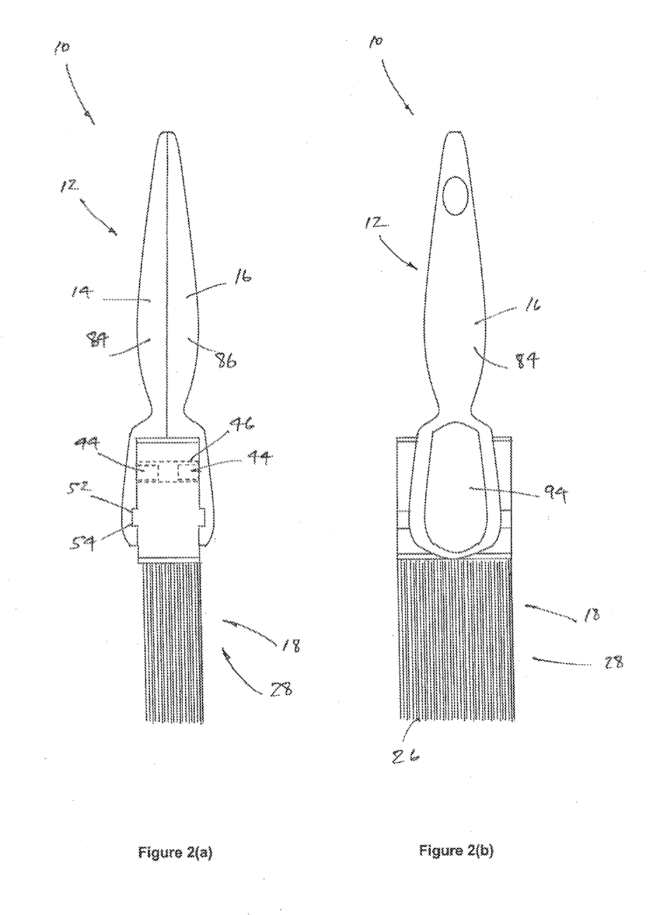

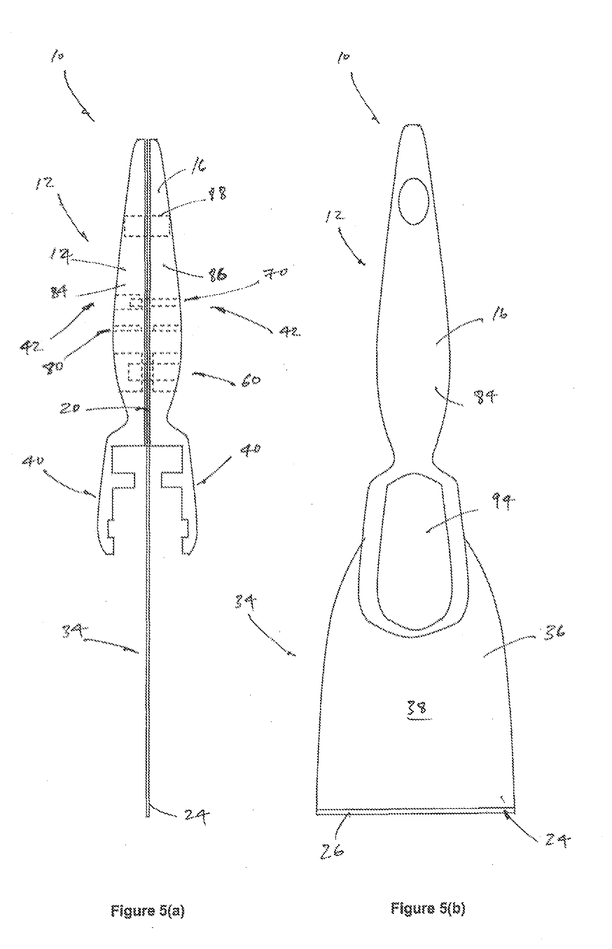

The first clamping member portions 40 of each clamping member 14, 16 selectively cooperate with one another to clamp the retention portion 20 of the first tool head 28 therebetween (as shown in FIGS. 1, 2(a) and 2(b)), while the second clamping member portions 42 of each clamping member 14, 16 selectively cooperate with one another to clamp the retention portion 20 of the second tool head 34 therebetween (as shown in FIGS. 4, 5(a), and 5(b)).

The retention portion 20 of the first tool head 28, as shown in FIG. 2(a), has a greater thickness than the retention portion 20 of the second tool head 34, as shown in FIG. 5(a).

Each first clamping member portion 40 includes a first retention formation 44 that is cooperable with a mutually engageable first retention formation 46 in the retention portion 20 of the first tool head 28. Cooperation of the first retention formations 44, 46 inhibits removal of the first tool head 28 from between the first clamping member portions 40.

In the embodiment shown, the first retention formation 44 is a cylindrical protrusion 48 which extends from each of the first and second clamping members 14, 16, and the mutually engageable first retention formation 46 is a circular aperture 50 of corresponding diameter to the cylindrical protrusion 48 which extends completely through the retention portion 20 of the first tool head 28.

In other embodiments of the invention (not shown) the first retention formations 44, 46 may differ from those described above. For example, they may be configured differently or have a different cross-sectional shape.

In still further embodiments of the invention (not shown), only one of the first clamping member portions may include a first retention formation which is cooperable with a corresponding mutually engageable retention formation in the retention portion of the first tool head.

Each first clamping member portion 40 also includes a first support formation 52 which is cooperable with a mutually engageable first support formation 54 in the retention portion 20 of the first tool head 28.

In particular, in the embodiment shown, the first support formation 52 is an elongate recess that is 56 formed in the corresponding clamping member 14, 16, and the mutually engageable first support formation 54 is an elongate protrusion 58 which extends from a corresponding side of the retention portion 20 of the first tool head 28.

In other embodiments of the invention, the first support formations 52, 54 may have a different configuration or cross-sectional shape to those described above.

In still further embodiments of the invention (not shown), only one of the first clamping member portions 40 may include a first support formation which is cooperable with a corresponding mutually engageable first support formation in the retention portion of the first tool head.

Each second clamping member portion 42 includes a primary retention formation 60 that is cooperable with a mutually engageable primary retention formation 62 in the retention portion 20 of the second tool head 34 to inhibit removal of the second tool head 34 from between the second clamping member portions 42, as illustrated in FIGS. 4, 5(a), and 5(b), which show the decorating tool 10 in a second configuration.

In particular, the first clamping member 14 includes a first recess formation 64, and the second clamping member 16 includes a first boss formation 66 which mutually engages with the first recess formation 64 to define the primary retention formation 60. The retention portion 20 of the second tool head 34 includes a first aperture 68 through which the primary retention formation 60 passes to inhibit separation of the second tool head 34 from the handle assembly 12. In other embodiments of the invention (not shown), the primary retention formations 60, 62 may differ from those shown.

Each second clamping member portion 42 also includes a secondary retention formation 70 that is cooperable with a mutually engageable secondary retention formation 72 in the retention portion 20 of the second tool head 34.

In particular, in the embodiment shown, the first clamping member 14 includes a second recess formation 74, and the second clamping member 16 includes a second boss formation 76 which mutually engages with the second recess formation 74 to define the secondary retention formation 70. The retention portion 20 of the second tool head 34 includes a second aperture 78 through which the secondary retention formation 70 passes to further inhibit separation of the second tool head 34 from the handle assembly 12. In other embodiments of the invention (not shown), the secondary retention formations 70, 72 may differ from those described above.

In addition, each second clamping member portion 42 also includes a second support formation 80. Each second support formation 80 is abuttable against the retention portion 20 of the second tool head 34.

The handle assembly 12 includes a handle body 82 that is formed from first and second mutually opposed handle portions 84, 86.

The first handle portion 84 defines the whole of the first clamping member 14 and the second handle portion 84 defines the whole of the second clamping member 84. In this way, each of the handle portions 84, 86 defines respective first and second clamping member portions 40, 42.

In the embodiment shown, each handle portion 84, 86 is molded from a plastics material. In other embodiments of the invention, the handle portions 84, 86 may be made from another material such as a wood or a metal.

In still further embodiments of the invention (not shown), each handle portion 84, 86 includes a corresponding first or second ferrule member, each of which defines one or both of the first and second clamping member portions. The first and second ferrule members cooperate with one another to form a ferrule which extends around the tool head 28, 34 and provides the desired clamping functionality of one or both of the first and second clamping member portions.

In other arrangements, the handle assembly may include a unitary handle body and first and second clamping members in, say, the form of first and second ferrule members, with each clamping member defining respective first and second clamping member portions.

The handle assembly 12 of the first embodiment additionally includes a fastener (not shown) to selectively secure the first and second handle portions 84, 86 to one another and thereby effect clamping of the retention portion 20 of the respective first or second tool head 28, 34.

One example of a suitable fastener is a screw or a bolt which passes through one handle portion 84, 86 and screwingly engages with the other handle portion 84, 86. In a preferred arrangement the fastener might extend concentrically through the primary retention formations 60, 62 of the second clamping member portions 42. The fastener may include an engagement formation to receive the head of a tool to affect tightening or loosening of the fastener, or it may include an actuator such as a handle or a lever to allow a user to directly tighten or loosen the fastener.

The handle assembly 12 further includes a biasing member 88, in the form of a compression spring 90, to urge the first and second clamping member portions 40, 42 away from one another to facilitate speedy removal and/or insertion of a retention portion 20 of a respective tool head 28, 34, therebetween.

The first and second handle portions 84, 86 are movably coupled with one another to allow selective separation of the first and second clamping member portions 40, 42 from one another without completely separating one handle portion 84, 86 from the other.

In particular, in the first embodiment shown, the first and second handle portions 84, 86 are hingedly coupled with one another at a distal end 92 thereof

The distal end 92 of one or other or both of the handle portions 84, 86 may also include a tool (not shown), such as a screwdriver bit, knife, hook, or the like.

Each of the handle portions 84, 86 in the embodiment shown includes a grip region 94 which is formed from a soft-touch material and provides a user with additional comfort and control over the associated for or second tool head 28, 34.

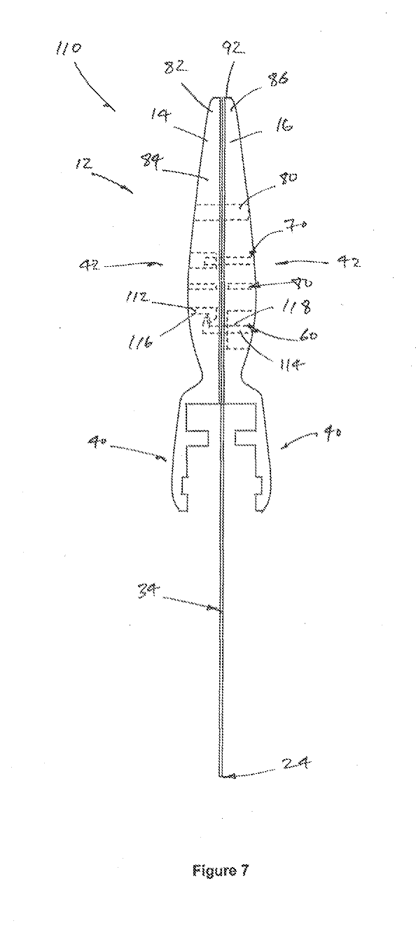

FIG. 7 shows a decorating tool 110 according to a second embodiment of the invention. The second decorating tool 110 is very similar to the first decorating tool 10, and like features share the same reference numerals.

One way in which the second decorating tool 110 differs from the first decorating tool 10 is with respect to the configuration of the primary retention formation 60 of the second clamping member portions 42.

In particular, the second decorating tool 110 includes second clamping member portions 42 from which extend respective mutually engageable fastening formations 112, 114.

In the embodiment shown, the fastening formations 112, 114 take the form of first and second barb formations 116, 118 which couple with one another to both retain the retention portion 20 of the second tool head 34 and fasten the first and second handle portions 84, 86 together.

In use, a user performs decorating tasks with the decorating tool 10, 110 of the invention in the same manner as he or she would with a conventional decorating tool.

However, when the operative portion 24 of a given tool head 28, 34 becomes worn or damaged, or the user wishes to perform a different decorating function, he is able to separate one tool head 28, 34 from the handle assembly 12 and replace it with another tool head 28, 34 (which is not worn or damaged, or has the desired functionality).

In particular, the user is able to able to separate the first tool head 28, 34 from the handle assembly by parting the first and second handle portions 82, 84 from one another to disengage the corresponding retention formations 44, 46, 60, 62, 70, 72. This may involve removing a fastener, as in the case of the first decorating tool 10, or prising apart first and second barb formations 116, 118, as in the case of the second decorating tool 110.

Once one tool head 28, 34 has been removed, a further tool head 28, 34 can be installed in its place by reversing the aforementioned steps.

A number of embodiments of the present invention have been described. Nevertheless, it will be understood that various modifications may be made without departing from the spirit and scope of the invention. Accordingly, other embodiments are within the scope of the following claims.

1-21. (canceled)

21. A decorating tool, for applying and removing material from a surface, comprising:
a handle assembly including selectively separable clamping members, the clamping members being defined at least in part by first and second handle portions of a handle body; and
a tool head including a retention portion lying towards a first end thereof and an operative portion lying towards a second end of the tool head opposite the first end, the operative portion being to apply or remove material from a surface;
the clamping members cooperating with one another to selectively clamp the retention portion of the tool head therebetween and thereby retain the tool head relative to the handle assembly; and
the clamping members cooperating with the retention portion to position the operative portion of the tool head beyond the handle assembly.

22. A decorating tool according to claim 21, wherein the handle assembly includes first and second mutually opposed clamping members.

23. A decorating tool according to claim 22, wherein each of the first and second clamping members includes respective first and second clamping member portions, the first clamping member portions selectively cooperating with one another to clamp the retention portion of a first tool head therebetween, and the second clamping member portions selectively cooperating with one another to clamp the retention portion of a second tool head therebetween, the retention portion of the first tool head having a greater thickness than the retention portion of the second tool head.

24. A decorating tool according to claim 23, wherein at least one first clamping member portion includes a first retention formation which is cooperable with a mutually engageable first retention formation in the retention portion of the first tool head to inhibit removal of the first tool head from between the first clamping member portions.

25. A decorating tool according to claim 24, wherein at least one first clamping member portion includes a first support formation which is cooperable with a mutually engageable first support formation in the retention portion of the first tool head to further reduce relative movement between the first tool head and the handle assembly.

26. A decorating tool according to any of claim 25, wherein at least one second clamping member portion includes a primary retention formation which is cooperable with a mutually engageable primary retention formation in the retention portion of the second tool head to inhibit removal of the second tool head from between the second clamping member portions.

27. A decorating tool according to claim 26, wherein at least one second clamping member portion includes a secondary retention formation which is cooperable with a mutually engageable secondary retention formation in the retention portion of the second tool head to further inhibit removal of the second tool head from between the second clamping member portions.

28. A decorating tool according to claim 27, wherein each second clamping member portion includes a primary retention formation which mutually engages with the primary retention formation of the other second clamping member portion and a secondary retention formation that mutually engages with the secondary retention formation of the other clamping member portion.

29. A decorating tool according to claim 28, wherein at least one second clamping member portion includes a second support formation which is abuttable against the retention portion of the second tool head.

30. A decorating tool according to claim 29, wherein each of the first and second handle portions defines at least a second clamping member portion.

31. A decorating tool according to claim 30, wherein each handle portion includes a corresponding first or second ferrule member, the first and second ferrule members defining at least a first clamping member portion.

32. A decorating tool, for applying and removing material from a surface, comprising:
a handle assembly including selectively separable clamping members, the clamping members being defined at least in part by first and second handle portions of a handle body;
wherein the handle assembly further includes a fastener to selectively secure the first and second handle portions to one another; and
a tool head including a retention portion lying towards a first end thereof and an operative portion lying towards a second end of the tool head opposite the first end, the operative portion being to apply or remove material from a surface;
the clamping members cooperating with one another to selectively clamp the retention portion of the tool head therebetween and thereby retain the tool head relative to the handle assembly; and
the clamping members cooperating with the retention portion to position the operative portion of the tool head beyond the handle assembly.

33. A decorating tool according to claim 32, wherein the fastener is defined by first and second mutually engageable fastener formations, each of which is integrally formed with a respective handle portion.

34. A decorating tool according to claim 33, wherein the handle assembly includes first and second mutually opposed clamping members.

35. A decorating tool according to claim 34, wherein each of the first and second clamping members includes respective first and second clamping member portions, the first clamping member portions selectively cooperating with one another to clamp the retention portion of a first tool head therebetween, and the second clamping member portions selectively cooperating with one another to clamp the retention portion of a second tool head therebetween, the retention portion of the first tool head having a greater thickness than the retention portion of the second tool head.

36. A decorating tool according to claim 35, wherein the handle assembly includes a biasing member to urge at least the first and second clamping member portions of one clamping member away from the first and second clamping member portions of the other clamping member.

37. A decorating tool according to claims 36, wherein the first and second handle portions are movably coupled with one another to allow selective separation of the first and second clamping member portions from one another without completely separating one handle portion from the other.

38. A decorating tool, for applying and removing material from a surface, comprising:
a handle assembly including selectively separable clamping members, the clamping members being defined at least in part by first and second handle portions of a handle body;
wherein the handle assembly further includes a fastener to selectively secure the first and second handle portions to one another;
a tool head including a retention portion lying towards a first end thereof and an operative portion lying towards a second end of the tool head opposite the first end, the operative portion being to apply or remove material from a surface;
the clamping members cooperating with one another to selectively clamp the retention portion of the tool head therebetween and thereby retain the tool head relative to the handle assembly;
the clamping members cooperating with the retention portion to position the operative portion of the tool head beyond the handle assembly; and
wherein said fastener is defined by first and second mutually engageable fastener formations, each of which is integrally formed with a respective handle portion.

39. A decorating tool according to claim 38, wherein the handle assembly includes first and second mutually opposed clamping members.

40. A decorating tool according to claim 39, wherein each of the first and second clamping members includes respective first and second clamping member portions, the first clamping member portions selectively cooperating with one another to clamp the retention portion of a first tool head therebetween, and the second clamping member portions selectively cooperating with one another to clamp the retention portion of a second tool head therebetween, the retention portion of the first tool head having a greater thickness than the retention portion of the second tool head.

41. A decorating tool according to claim 40, wherein at least one first clamping member portion includes a first retention formation which is cooperable with a mutually engageable first retention formation in the retention portion of the first tool head to inhibit removal of the first tool head from between the first clamping member portions.

42. A decorating tool according to claim 41, wherein at least one first clamping member portion includes a first support formation which is cooperable with a mutually engageable first support formation in the retention portion of the first tool head to further reduce relative movement between the first tool head and the handle assembly.

43. A decorating tool according to claim 42, wherein at least one second clamping member portion includes a primary retention formation which is cooperable with a mutually engageable primary retention formation in the retention portion of the second tool head to inhibit removal of the second tool head from between the second clamping member portions.

44. A decorating tool according to claim 43, wherein at least one second clamping member portion includes a secondary retention formation which is cooperable with a mutually engageable secondary retention formation in the retention portion of the second tool head to further inhibit removal of the second tool head from between the second clamping member portions.

45. A decorating tool according to claim 44, wherein each second clamping member portion includes a primary retention formation which mutually engages with the primary retention formation of the other second clamping member portion and a secondary retention formation that mutually engages with the secondary retention formation of the other clamping member portion.

46. A decorating tool according to claim 45, wherein at least one second clamping member portion includes a second support formation which is abuttable against the retention portion of the second tool head.

47. A decorating tool according to claim 46, wherein each of the first and second handle portions defines at least a second clamping member portion.

48. A decorating tool according to claim 47, wherein each handle portion includes a corresponding first or second ferrule member, the first and second ferrule members defining at least a first clamping member portion.

49. A handle assembly for a decorating tool configured to apply or remove material from a surface, the handle assembly comprising selectively separable clamping members, the clamping members being defined at least in part by first and second handle portions of a handle body and being cooperable with one another to selectively clamp a retention portion of a tool head therebetween to retain the tool head relative to the handle assembly, the clamping members further being cooperable with the retention portion to position an operative portion of the tool head configured to apply or remove material from a surface beyond the handle assembly.

50. A tool head for a decorating tool configured to apply or remove material from a surface, the tool head comprising a retention portion lying towards a first end thereof and an operative portion lying towards a second end of the tool head opposite the first end, the operative portion being to apply or remove material from a surface, the retention portion being clampable between clamping members defined at least in part by first and second handle portions of a handle body forming part of a handle assembly to retain the tool head relative to the handle assembly, and the retention portion being cooperable with the clamping members to position the operative portion of the tool head beyond the handle assembly.
